(19) United States
(12) Patent Application Publication
(10) Pub. No.: US 2018/0086382 A1
(43) Pub. Date: Mar. 29, 2018

(54) DEVICE FOR CAMBER ANGLE CORRECTION

(71) Applicant: Gahotech Sistemas Automotivos EIRELI - EPP, Ituporanga (BR)

(72) Inventor: Adilson Garcia, Ituporanga (BR)

(21) Appl. No.: 15/274,779

(22) Filed: Sep. 23, 2016

(51) Int. Cl. B62D 17/00; F15B 11/08; B60G 7/00

(52) U.S. Cl. CPC B62D 17/00; F15B 11/08; B60G 2204/61; F15B 2211/205; B60G 7/006

(57) ABSTRACT

“DEVICE FOR CAMBER ANGLE CORRECTION” refers to a device's constructive setting for the correction of camber angle in automotive vehicles that can be used in various types of suspension and not just the “MacPherson” ones, increasing its possibilities of application and turning it universal. Said device comprises a hydraulic pump, which hose is connected to a positive and negative action hydraulic cylinder (11), and said hydraulic pump has directional valve, and the hydraulic piston (11) provides also a hub (12) for a support base near the end of the rod movement of said hydraulic piston (11). This said support base can be a straight support base (20) fixed at the wheel hub, or a curved auxiliary support base (30) fixed in the vehicle's shaft sleeve; and the rod tip of the hydraulic piston (11) should be attached on a fixing bracket (40) which in turn is fitted around the car's suspension column.

The object of the present application describes a device's constructive setting for the correction of camber angle in automotive vehicles.

Camber is the angle formed by the inclination of the wheels in relation to a vertical plane, if camber angle is incorrect, when from one degree more than the manufacturer's recommendation, for positive or negative, it will cause uneven wear on the tire tread and also vibrations in the vehicle's steeering, ensuring in soil evenly and less tire wear, as well as stability in steeering.

In the current state of the art are known several types of devices for the correction of camber angle in vehicles, in particular to “MacPherson” type suspensions, because it is a type of suspension widely used in front wheel drive cars. Several mechanical stresses from the car use, cause warping in the damper column, causing changes in geometry or alignment of the suspension camber angle.

It may be cited as previous registrations the patent document PI0300742-1 that describes that an improvement in alignment equipment, more specifically in relation to the measurement of misalignment, aiming to increase the accuracy of alignment equipment.

The same inventor has developed a tool for correction of camber angle, patent granted with number MU7602145-9. This document revealed advantages especially regarding the “MacPherson” suspension camber correction. Said revealed tool uses hydraulic, manual or electric pump, which hose is connected to a positive action hydraulic cylinder or a negative action hydraulic cylinder, and in both cases, such cylinders for camber adjustment, act on a support, comprised of a base having universal holes, surrounding a central hole, which has oblong opening located on its shaft, said support being fixed with bolts crossing the holes, holding it directly or indirectly with the aid of a base connected to the front suspension shaft′ sleeve of the automobile.

The inventor observed a wide range of modifications that could be made in order to further solve more problems arising from the damper column alignment correction process, which was not only in “MacPherson” suspension.

One of the problems identified was to find a practical solution to be able to meet the largest number of damper column types from different vehicles, using the same mechanism. This would solve the problem of needing several equipment for many different types of vehicles.

It was also identified another drawback in previous technical registrations, particularly to the existing equipment, developed by the same inventor, for a type of suspension, it is in the fact of using two cylinders: a positive action hydraulic cylinder or a negative action hydraulic cylinder so that the operator should change cylinder, whenever it was necessary to reverse the direction of the cylinder's action.

Another detail seeking improvement, in order to result in a universal equipment, it is related to the assembly base; this base is equipped with universal holes surrounding a central hole, and had an oblong opening, wherein said oblong opening made even more difficult the assembly process of the vehicle's suspension, especially the provision and replacement of cylinders.

Another problem which granted difficulty in assembly, operation and execution of the equipment consists in the fact of using an alternative assembly comprised of a clamp, attached to a bolt and having a nut, wherein said assembly was mounted on the shaft′ sleeve support of some vehicle models.

Generally the previous technique, especially described in patent document MU7602145-9, had a constructive manner in which the assembly comprising the support base was to be attached to the vehicle wheel hub with a plurality of holes, corresponding to different holes of vehicle wheels, which were treated at the time of its development. And in case a reinforcement was necessary supplemented to the system with the use of an alternative set, comprised of a clamp, attached to a bolt and having a nut, which was also mounted on the support base of the equipment and fixed in the sleeve support shaft some vehicle models. And it showed mounting difficulty owing to the mounting position of the support base, the need to exchange cylinders when needed to reverse the action and with the use of a complementary set for some specific vehicle models. All this, being used only for “MacPherson” type suspension.

The modifications applied to the new device for the camber correction in automotive vehicles, mainly refers to the fact that they can be used in various suspension types and not just the “MacPherson” ones, increasing its possibilities of application and making it universal.

In order to increase the operating convenience and expansion of suspension types in which the system can be applied to, the new constructive setting of the device for the camber angle correction uses a hydraulic system where only one double action piston, performs the camber angle correction both positive and negative, thus, the hydraulic pump may be replaced by a pump with control valve system which when actuated from one side to the other allows to direct the flow of oil as required by operation, causing the double action piston to be actuated in both directions, back and forth.

Another important difference in constructive form of support base, which was made to serve a greater number of vehicles, further facilitates the alignment operation and cylinder assembly, the oblong hole has been replaced by a fork type constructive form. Even in the current system, the holes to hold the wheel hub were replaced by oblong slots, which allows a much greater range and is compatible with many vehicles and their various wheels drilling measures.

Although the shape of the pattern as the support base, the prior art makes it difficult to assemble and disassemble the cylinder, because it does not provide a solution to some types of cars, where the fixing of the support base, and screw can not be made to the wheel hub, or fixing the wheel hub may cause damage to the bearing, and then must be fixed otherwise; Therefore, the pattern support base has been modified so as to comprise different geometric shapes, especially with a standard model, which is fitted in the hub itself or a curved pattern which allows its fixing in the rear wheel hub. Thus, the support base used will depend on the vehicle type so as to allow fixing the cylinder in the suspension column of the vehicle, to perform the alignment.

Another feature that shows superiority from a technical point of view, in relation to the state of the art, is the constructive arrangement of accessories that are designed to meet a greater number of vehicles, following the upgrade of the fleet.

Said equipment operates for correction of wheel tilt, limited to a certain degree of inclination, both positive and negative, especially in 1 degree range; and usually it uses the equipment at temperatures from 5 to 45° C. The application of such equipment is also applied in suspension (sleeve/column), a flexibility that can be up to 2 degrees of geometric tilt, for both negative and positive without prejudice of breaking in any part of the vehicle suspension. All the effort and work done, is below the technical specifications of parts and supports the application of the equipment safely within the established limit of components resistance that were submitted to the work.

The constructive setting of the device for the correction of camber angle in automotive vehicles, object of this patent application is best understood using the detailed description presented below, along with the accompanying drawings, given by way of example and illustration, and not limiting the object of the present application, including:

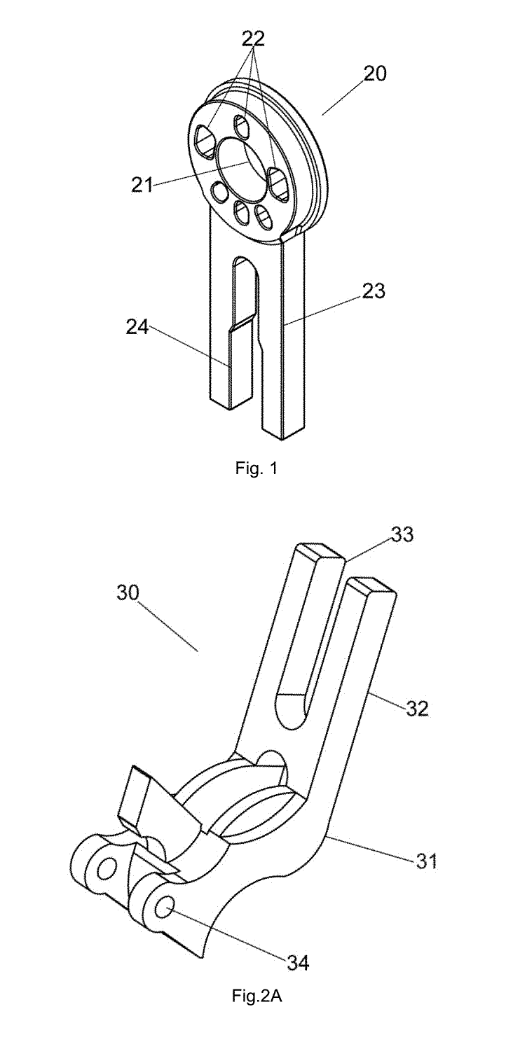

FIG. 1 shows a perspective view of support base (20), which is the one fixed on the wheel hub.

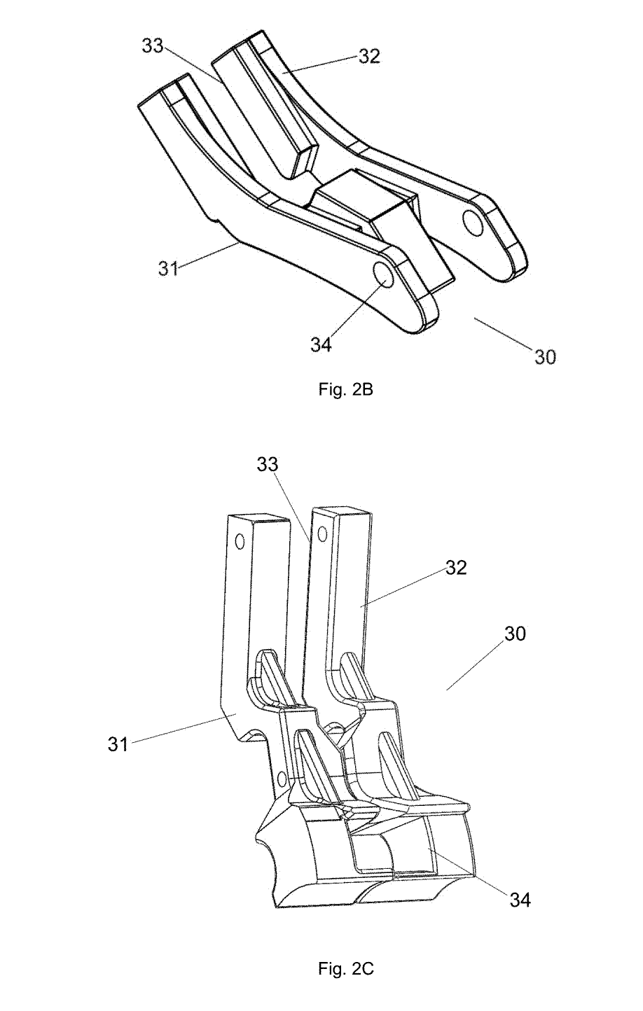

FIGS. 2A, 2B, 2C and 2D show perspective views of some possible shapes for the curved auxiliary support base (30), which will be fixed on the shaft′ sleeve.

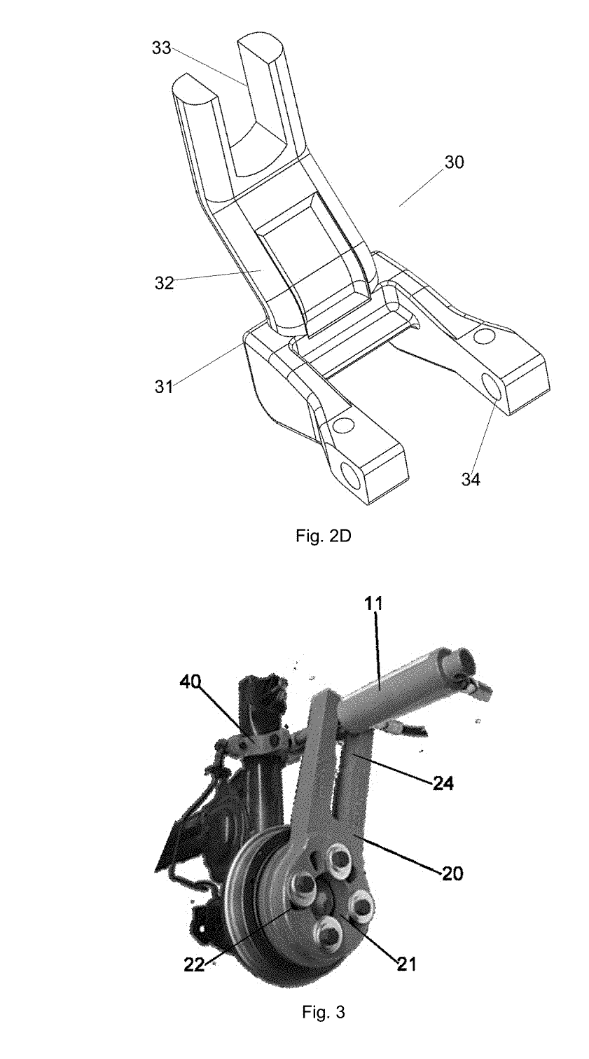

FIG. 3 shows an embodiment of device, using the support base (20); in cars where fixation will be made by the wheel hub.

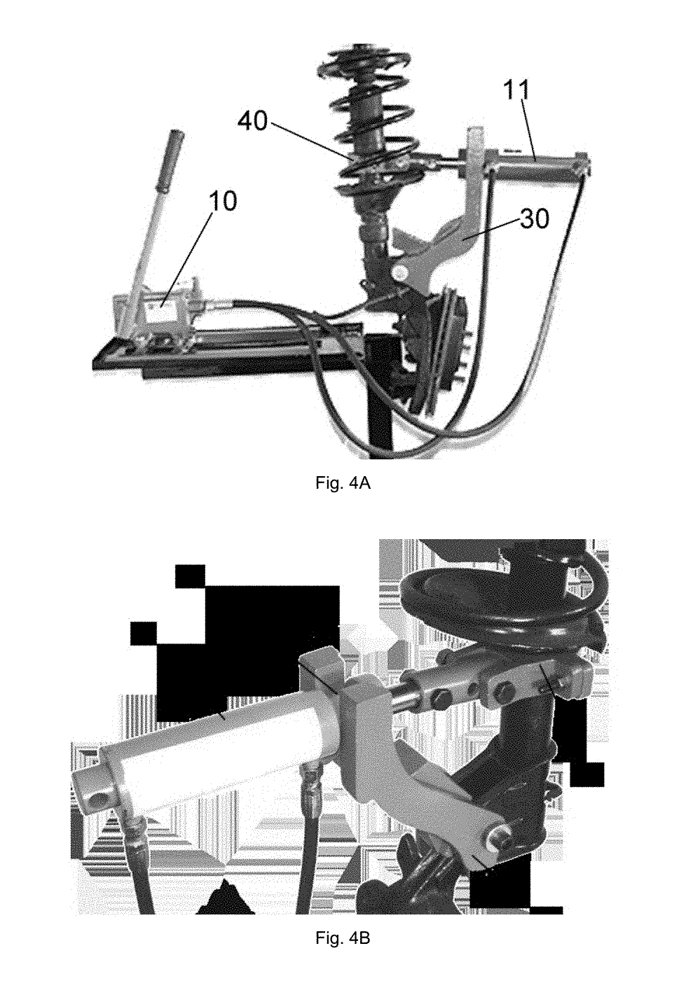

FIGS. 4A and 4B show possible embodiments to curved auxiliary support base (30); used in cars where fixation shall be made by the shaft′ sleeve.

In reference to the figures presented, said device comprises a hydraulic pump (10) with directional valve, a double action hydraulic piston (11), with fitting (12) near the end of its drive shaft; this fitting (12) has the function to hold the support base (20) or auxiliary support base (30); technically this fitting (12) enables the use of double action hydraulic piston (11), since both in advance and in reverse, the fitting (12) allows the support base to be pushed or pulled by said piston; Unlike the previous configuration that the piston had to be replaced and repositioned, being one for pushing the shaft and the other to pull.

The support base (20), shown in FIG. 1, is going attached to the wheel hub; includes a central lug (21) provided with universal holes (22), especially oblong, especially sized to be concentric to the wheel hub holes of various types of vehicles, this lug (21) has an extension (23) with a fork (24), allowing the coupling of the fitting (12) of the cylinder (11). The fork shape, which is open at one end favors the ease of assembly of the hydraulic piston (11); the spacing is compatible to that of said piston fitting. The end of the hydraulic piston shaft (11) should be attached on a fixing bracket (40) which in turn is fitted around the car's suspension column.

FIGS. 2A, 2B, 2C and 2D show format variations of the auxiliary support base (30), having curved body (31), differently from the support base (20). This format setting is used so that said auxiliary support base (30) is used in cars where fixing has to be done by shaft sleeve, and not by wheel hub. It also provides for an extension (32) and a fork (33) with spacing to enable fitting the hydraulic piston (11); further comprising means for its fixing (34) that can be positioned at the lower end, the upper end or the central region of said body (31) or in more than one place simultaneously, without destroying the inventive concept of the object.

FIG. 3 then shows a device mounted on a car where the fixing should be made by the wheel hub. In this condition, it uses the support base (20) whose configuration is for such a purpose. Thus the support base (20) is positioned so that the lug (21) becomes concentric to the wheel hub and the holes are used (22) compatible for fixing to the hub; it's positioned the hydraulic piston (11) in the spacing of the forks (24) holding its rod close to the car suspension, by means of a fixing bracket (40). The hydraulic piston (11) must be coupled to the hydraulic pump (10) with directional valve.

FIGS. 4A and 4B illustrate assemblies using the device, but in a car where the fixing must be made by the shaft sleeve. For this case, the auxiliary support base is used (30) curved, with their most appropriate format. Was used for purposes of illustration a base with the body (31) curved, and the extension (32) also with the same concept, having a fork-shaped (33) to couple the hydraulic piston (11), and uses a means fixing (34) to secure it to said swing axis, which may be a screw positioned in holes in the auxiliary support base (30) and tightening a clamp around the shaft sleeve, and a screw positioned in holes in the auxiliary support base (30) and which is fixed directly on the shaft sleeve, but without destroying the inventive concept of the auxiliary support base (30); they may also present some small differences in shape, it will be appropriate to better fit into certain types of suspension. However, these format variations should not disfigure the object of this document.

For a better understanding of the use of the device, it must be used as follows: First position to the vehicle in alignment ramp specific equipment performs the diagnosis of alignment, then the vehicle is lifted and the wheel is removed, the hand where needed to correct it. Then installs directly into the vehicle's wheel hub, the support base (20), if this is the most appropriate condition; or settles directly on the sleeve shaft of the vehicle, the auxiliary support base (30) curve with the most suitable shape for the car. It is then installed hydraulic piston (11) by placing its seat (12) on the yoke (24 or 33 dependent on the base format) and said hydraulic piston (11) must be coupled to the hydraulic pump (10) with directional valve; then the end of the hydraulic piston rod (11) is coupled to a fixing bracket (40) which is fixed to the vehicle suspension column. It makes up the correction procedure.

The support point can be the wheel hub, for some cases, when using the support base (20) or the shaft sleeve, in other cases, when using the auxiliary support base (30); then a force is exerted by the hydraulic pump, which will push or pull the vehicle's suspension column to the point of correcting warping that caused misalignment.

This action is controlled through a slit (not shown), which will measure how much is being moved, giving precision in the final result; once reached the required shift, take it apart if the camber correction for device parts and becomes to make the diagnosis to confirm that the vehicle is to the wheel alignment measurements within the standards established by the same manufacturer.

Making it clear that the curved auxiliary support base (30), compatible to allow its fixing to the vehicle's shaft sleeve, is used for vehicles which cannot use the straight support base (20). This can have various shapes since small adjustments in the curvature or shape can facilitate their use in some vehicle models. The position of their fixation means (34) may also vary and may especially be at the lower end of said base, or more in the central region, or more at the upper end. The positioning of the support base holes (20) can also have minor changes to be suitable to serve the maximum number of available wheel hubs.

1. DEVICE FOR CAMBER ANGLE CORRECTION, comprising a hydraulic pump, which hose is connected to a positive and negative action hydraulic cylinder (11), characterized by the hydraulic pump, it has directional valve and the hydraulic piston (11) provides fitting (12) support base near the end of the rod movement of said hydraulic piston (11), which can be a straight support base (20) fixed to the wheel hub, or a curved auxiliary support base (30) fixed to the shaft sleeve of the vehicle; and at the tip of the hydraulic piston (11) should be coupled a fixing bracket (40) which in turn is fitted around the car's suspension column.

2. DEVICE FOR CAMBER ANGLE CORRECTION, according to claim 1, characterized by support base (20), comprises a central lug (21), surrounded by universal holes (22) and has an extension (23) with a fork (24), with spacing compliant to allow engagement of fitting (12) of the cylinder (11) and its adjustment along the spacing.

3. DEVICE FOR CAMBER ANGLE CORRECTION, according to claim 1, characterized by the curved auxiliary support base (30), it has extension (32) and a fork (33) with spacing to enable the hydraulic piston fitting (11) and has fastening means (34) at the shaft sleeve of the vehicle.

4. DEVICE FOR CAMBER ANGLE CORRECTION, according to claim 1, characterized by the fixing mean (34) to be a screw positioned in holes at the auxiliary support base (30) and tightening a clamp around the shaft sleeve.

5. DEVICE FOR CAMBER ANGLE CORRECTION, according to claim 1, characterized by the fixing mean (34) to be a screw positioned in holes at the auxiliary support base (30) and tightening directly the shaft sleeve.

6. DEVICE FOR CAMBER ANGLE CORRECTION, according to claim 1, characterized by fitting (12) of hydraulic piston (11) to be an extension on the cylinder end with a compatible recess to fit the fork spacing (24 or 33), of the support base (20) or auxiliary support base (30).
